(19) United States
(12) Patent Application Publication
(10) Pub. No.: US 2004/0167979 A1
(43) Pub. Date: Aug. 26, 2004

(54) Automatic configuration of metric components in a service level management system

(75) Inventors: Glenn C. Aikens, Raleigh, NC (US); Bradford Austin Fisher, Chapel Hill, NC (US); Brian David Jeffrey, Cary, NC (US); Kevin J. Kuhner, Cary, NC (US); Robert Louis Nielsen, Chapel Hill, NC (US); Jeffrey Michael Summers, Cary, NC (US); Doug Kevin Willenborg, Apex, NC (US)

Correspondence Address: Steven M. Greenberg, Esquire, Akerman, Senterfitt P.A., Post Office Box 3188, West Palm Beach, FL, 33401-3188, US

(73) Assignee: International Business Machines Corporation, Armonk, NY (US)

(21) Appl. No.: 10/370,640

(22) Filed: Feb. 20, 2003

(51) Int. Cl. G06F 15/173

(52) U.S. Cl. 709/225

(57) ABSTRACT

A service level management (SLM) configuration system and method. The SLM configuration system can include a data store having one or more references to metric components. A discovery processor can be coupled to the data store and programmed to identify individual ones of the metric components through the references which can be incorporated in a service level agreement (SLA) and managed by an associated SLM system. Finally, a registration processor can be coupled both to the discovery processor and to the associated SLM system. The registration processor can have a configuration for adding identified ones of the metric components to the associated SLM system for management by the associated SLM system when the identified ones of the metric components are incorporated into an SLA managed by the associated SLM system.

### BACKGROUND OF THE INVENTION

1. Statement of the Technical Field

The present invention relates to policy based service differentiation and more particularly to the selection and configuration of metric components for use in a service level management (SLM) system.

2. Description of the Related Art

The vast majority of network devices process device requests indiscriminately. That is, regardless of the identity of the requester or the type of request, each device request can be processed with equal priority. Given the exponential increase in network traffic across the Internet, however, more recent network-oriented computing devices have begun to provide varying levels of computing services based upon what has been referred to as a “policy based service differentiation model”.

The policy based service differentiation model is the logical result of several factors. Firstly, the number and variety of computing applications which generate requests across networks both private and public has increased dramatically in the last decade. Each of these applications, however, has different service requirements. Secondly, technologies and protocols that enable the provision of different services having different security and service levels have become widely available. Yet, access to these different specific services must be regulated because these specific services can consume important computing resources such as network bandwidth, memory and processing cycles. Finally, business objectives or organizational goals can be best served when discriminating between different requests rather than treating all requests for computer processing in a like manner.

In a policy based service differentiation model, the computing devices can offer many levels of service where different requests for different content or services which originate from different requestors receive different levels of treatment depending upon administratively defined policies. In that regard, a service level agreement (SLA) can specify a guaranteed level of responsiveness associated with particular content or services irrespective of any particular requestor. Formally defined, an SLA can include an agreement or contract between a service provider and a customer of that service, which sets expectations for the level of service with respect to availability performance, and other measurable objectives.

Service level management (SLM), by comparison, is the process of negotiating, defining and managing the levels of information technology services which are both required and cost-justified. SLM can include iterative, disciplined, proactive methodologies and procedures used to ensure that adequate levels of service are delivered to all users in accordance with business priorities and at acceptable cost. Thus, the skilled artisan will recognize that the touchstone to SLM can include correctly quantifying the services being provided.

Notably, SLM products have been developed to perform SLM in regard to one or more SLAs or similarly defined arrangements in which computing services are to be provided to users. In general, to configure an SLM system to monitor the metrics associated with computing services in accordance with the terms of an SLA, initially the metric components must be manually identified to the SLM system. Metric components are known in the art to include computing elements configured to monitor and report performance metrics relating to computing services, for example operational data, performance data, or availability data.

In any case, to complete the configuration of the SLM system, identified metric components must be registered with the SLM system and configured for use by the SLM system. Still, the process of manually selecting and configuring metric components for use in an SLM system both can be unwieldy and error prone. Accordingly, there remains a long felt, unsolved need for an improved method for configuring metric components for use in an SLM system.

### SUMMARY OF THE INVENTION

The present invention is a system and method for automatically configuring a metric component for use in an SLM system. Inasmuch as the system and method of the invention is an automatic system and method, the present invention can overcome the unwieldy and error prone nature of manually configuring metric components. To that end, metric components residing in a data warehouse and able to support selected terms of an SLA can be automatically discovered within the data warehouse. Upon discovery, the metric component can be registered in the SLM system and configured for use. Once configured, the metric component can be referenced within any SLA offered by the SLM system.

In one aspect of the present invention, a method for configuring a metric component for use in an SLM system can include inspecting metric component references in a data store to identify individual ones of the metric component references which indicate that a corresponding metric component both can be incorporated in an SLA and also managed by the SLM system. For each metric component reference identified in the inspecting step, the corresponding metric component can be configured for use in the SLM system.

Notably, in a preferred aspect of the present invention, the data store can be a datamart. In this regard, the method of the invention further can include the step of loading the metric component references into the datamart from a data warehouse using an extraction, transformation and loading (ETL) process. Importantly, for each metric component reference in the data store, the inspecting step can include determining from the reference whether the corresponding metric component can monitor and report at least one of operational data, performance data and availability data for the corresponding metric component. Also, for each metric component reference identified in the inspecting step, the configuration step can include adding the corresponding metric component to a service catalog in the SLM system.

In another aspect of the present invention, an SLM configuration system can be provided which can include a data store having one or more references to metric components. A discovery processor can be coupled to the data store and programmed to identify individual ones of the metric components through the references which can be incorporated in an SLA and managed by an associated SLM system. Finally, a registration processor can be coupled both to the discovery processor and to the associated SLM system. The registration processor can have a configuration for adding identified ones of the metric components to the associated SLM system for management by the associated SLM system when the identified ones of the metric components are incorporated into an SLA managed by the associated SLM system.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of an SLM architecture arranged to support the automatic identification and configuration of metric components in an SLM system; and,

FIG. 2 is a flow chart illustrating a process for automatically configuring metric components for use with the SLM system of FIG. 1.

### DETAILED DESCRIPTION OF THE PREFERRED EMBODIMENTS

The present invention is a system and method for automatically identifying metric components programmed to support automated management according to terms common to an SLA. Specifically, individual metric components can be discovered in a data warehouse. Once identified, a metric component can be configured for use in an associated SLM. In consequence, the configured metric component can be incorporated into an SLA managed by the SLM. As part of an SLA managed by the SLM, the metric component can support the SLM in its monitoring of the operation, performance and availability of system resources to ensure that the terms of the SLA are met with respect to the system resources.

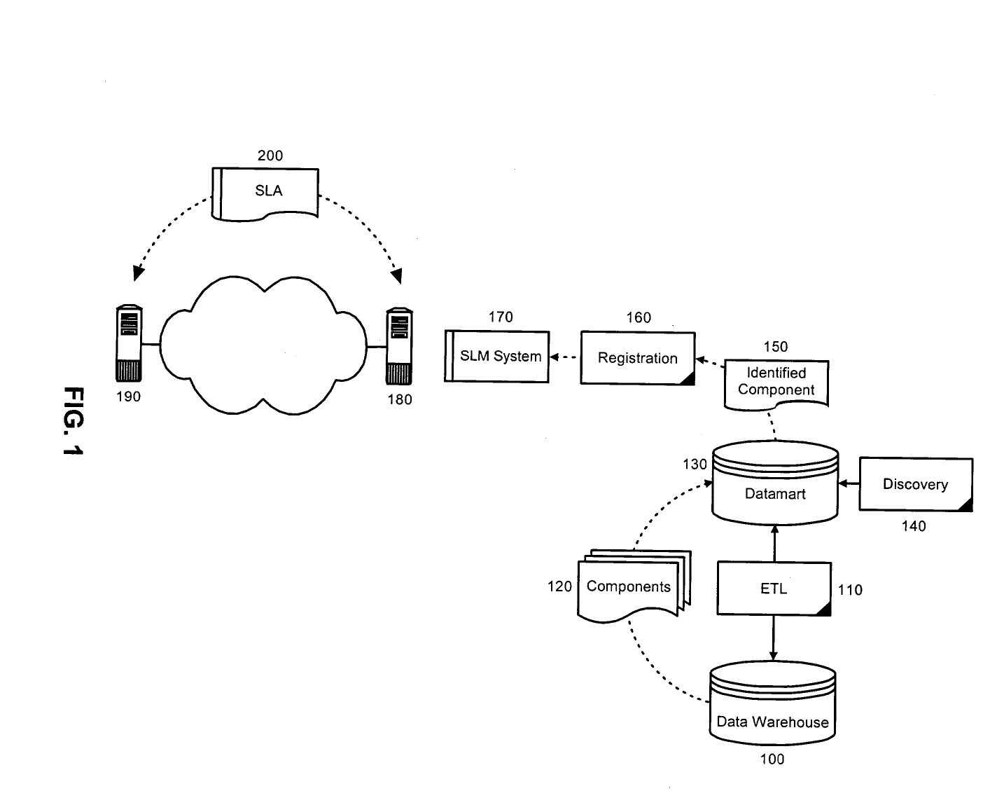

FIG. 1 is a schematic illustration of an SLM architecture arranged to support the automatic identification and configuration of components in an SLM system. Specifically, the SLM architecture can include a data warehouse 100 housing data a subset of which can include metric components 120. A datamart 130 can be coupled to the data warehouse 100 in which the subset of the metric components 120 can be stored for use by a component discovery process 140. Specifically, a conventional extraction, transformation and loading (ETL) process 110 can be applied to the data warehouse 100 to populate the datamart 130 with the subset of metric components 120.

The component discovery process 140 can process each record in the datamart 130 to identify those of the subset of metric components 120 which can support the types of terms associated with an SLA. As an example, based upon a review of a component record in the datamart 130, it can be determined whether the metric component can support the monitoring and reporting of operational and/or performance data. Similarly, based upon a review of the component record in the datamart 130, it can be determined whether the metric component can support the monitoring and reporting of availability data. In all cases, the determination can be undertaken by reference to the interface to the metric component published within the datamart 130.

It will be recognized by one skilled in the art that the invention is not limited strictly to the foregoing tests to determine whether the metric component supports terms of an SLA. Rather, it should be understood that an SLA can include a multiplicity of performance and availability metrics related to the connectivity, availability and responsiveness of the metric component. So long as the metrics can be monitored and reported by the metric component, or where the metric component can facilitate the monitoring of the metrics through an interface, the application can be said to support the terms of an SLA.

Once identified, the identified component 150 can be forwarded to a registration process 160. The registration process 160 can insert the identified component 150 into a service catalog of the SLM system 170. Once inserted into the service catalog of the SLM system 170, the identified component 150 can be made available to users of the SLM system 170. Specifically, the end user can incorporate the identified component 150 as part of an SLA 200 established between an affiliated provider 180 and client 190.

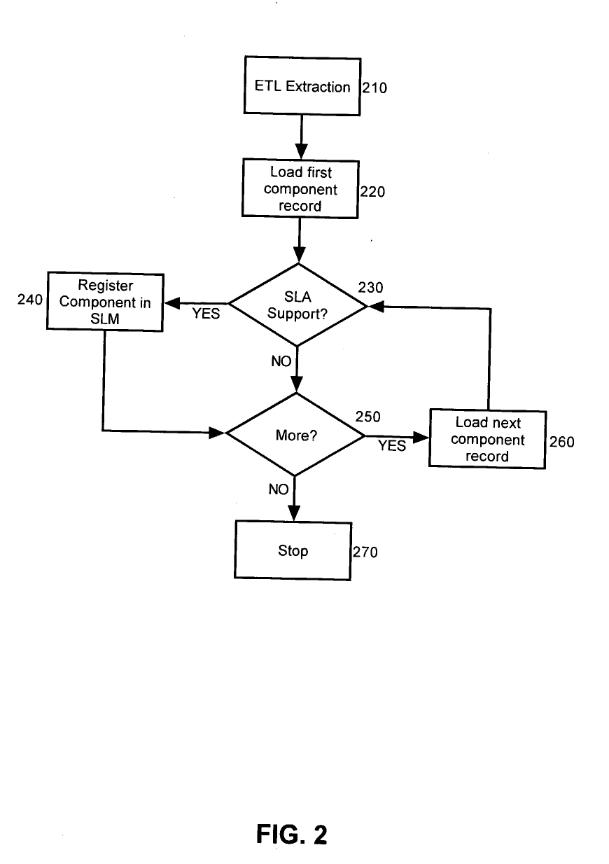

FIG. 2 is a flow chart illustrating a process for automatically configuring components for use with the SLM system 170 of FIG. 1. Beginning in block 210, an ETL extraction process can load a subset of metric components into a datamart for use by the component discovery process of the present invention. In block 220, the first component record in the datamart can be loaded for inspection. In decision block 230, it can be determined from the record whether an associated metric component can support the management of the terms of an SLA. In so, in block 240 the component can be registered in the SLM system.

Whether or not the component can support an SLA, in decision block 250 it can be determined whether additional records in the datamart remain to be inspected. If so, in block 260 the next component record can be loaded. Subsequently, the discovery process can repeat in blocks 230 through 250. If not, the process can terminate in block 270. Importantly, the discovery process of the present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for configuring an metric component for use in a service level management (SLM) system, the method comprising the steps of:
inspecting metric component references in a data store to identify individual ones of said metric component references which indicate that a corresponding metric component can be incorporated in a service level agreement (SLA) and managed by the SLM system; and,
for each metric component reference identified in said inspecting step, configuring said corresponding metric component for use in the SLM system.

2. The method of claim 1, wherein said data store is a datamart.

3. The method of claim 2, further comprising the step of:
loading said metric component references into said datamart from a data warehouse using an extraction, transformation and loading (ETL) process.

4. The method of claim 1, wherein said inspecting step comprises the steps of:
for each metric component reference in said data store, determining from said reference whether said corresponding metric component can monitor and report at least one of performance data and availability data for said corresponding metric component.

5. The method of claim 1, wherein said configuring step comprises the step of:
for each metric component reference identified in said inspecting step, adding said corresponding metric component to a service catalog in the SLM system.

6. A service level management (SLM) configuration system comprising:
a data store comprising a plurality of references to metric components;
a discovery processor coupled to said data store and programmed to identify individual ones of said metric components through said references which can be incorporated in a service level agreement (SLA) and managed by an associated SLM system; and,
a registration processor coupled both to said discovery processor and to said associated SLM system, said registration processor having a configuration for adding identified ones of said metric components to said associated SLM system for management by said associated SLM system when said identified ones of said metric components are incorporated into an SLA managed by said associated SLM system.

7. The system of claim 6, further comprising:
a data warehouse comprising a superset of said references; and,
an extraction, transformation and loading (ETL) processor coupled both to said data store and said data warehouse, said ETL processor having a configuration for loading a subset of said superset into said data store as said references which can be processed in said discovery processor.

8. A machine readable storage having stored thereon a computer program for configuring an metric component for use in a service level management (SLM) system, the computer program comprising a routine set of instructions for causing the machine to perform the steps of:
inspecting metric component references in a data store to identify individual ones of said metric component references which indicate that a corresponding metric component can be incorporated in a service level agreement (SLA) and managed by the SLM system; and,
for each metric component reference identified in said inspecting step, configuring said corresponding metric component for use in the SLM system.

9. The machine readable storage of claim 8, wherein said data store is a datamart.

10. The machine readable storage of claim 9, further comprising the step of:
loading said metric component references into said datamart from a data warehouse using an extraction, transformation and loading (ETL) process.

11. The machine readable storage of claim 8, wherein said inspecting step
comprises the steps of:
for each metric component reference in said data store, determining from said reference whether said corresponding metric component can monitor and report at least one of performance data and availability data for said corresponding metric component.

12. The machine readable storage of claim 8, wherein said configuring step
comprises the step of:
for each metric component reference identified in said inspecting step, adding said corresponding metric component to a service catalog in the SLM system.
